(19) United States
(12) Patent Application Publication
(10) Pub. No.: US 2008/0013218 A1
(43) Pub. Date: Jan. 17, 2008

(54) Magnetoresistive effect element, magnetic head, magnetic reproducing apparatus, and manufacturing method thereof

(75) Inventors: Hiromi Fuke, Yokohama-shi (JP); Susumu Hashimoto, Nerima-ku (JP); Masayuki Takagishi, Kunitachi-shi (JP); Hitoshi Iwasaki, Yokosuka-shi (JP); Masashi Sahashi, Sendai-shi (JP); Masaaki Doi, Sendai-shi (JP); Kousaku Miyake, Sendai-shi (JP)

Correspondence Address: NIXON & VANDERHYE, PC, 901 NORTH GLEBE ROAD, 11TH FLOOR, ARLINGTON, VA, 22203, US

(73) Assignees: KABUSHIKI KAISHA TOSHIBA, Tokyo (JP); TDK CORPORATION, Tokyo (JP)

(21) Appl. No.: 11/822,700

(22) Filed: Jul. 9, 2007

(30) Foreign Application Priority Data
Jul. 11, 2006 (JP) 2006-190846

(51) Int. Cl. G11B 5/33

(52) U.S. Cl. 360/313

(57) ABSTRACT

A magnetoresistive effect element, includes: a magnetoresistive effect film including: a magnetization fixed layer having a first ferromagnetic film of which magnetization direction is practically fixed in one direction; a magnetization free layer having a second ferromagnetic film of which magnetization direction changes with corresponding to an external magnetic field; and a spacer layer disposed between the magnetization fixed layer and magnetization free layer, and having an insulating layer and a ferromagnetic metal portion penetrating through the insulating layer; a pair of electrodes applying a sense current in a perpendicular direction relative to a film surface of the magnetoresistive effect film; and a layer containing a non-ferromagnetic element disposed at least one of an inside of the magnetization fixed layer-and an inside of the magnetization free layer.

### CROSS-REFERENCE TO THE RELATED APPLICATIONS

This application is based upon and claims the benefit of priority from the prior Japanese Patent Application No. 2006-190846, filed on Jul. 11, 2006; the entire contents of which are incorporated herein by reference.

### BACKGROUND OF THE INVENTION

1. Field of the Invention

The present invention relates to a magnetoresistive effect element, a magnetic head, a magnetic reproducing apparatus, and a manufacturing method thereof in which a sense current is flowed in a perpendicular direction relative to a film surface of a magnetoresistive effect film.

2. Description of the Related Art

A magnetoresistive effect element is used for a magnetic field sensor, a magnetic head (MR head), an MRAM, a DNA-MR chip and so on, or an application thereof has been studied (refer to APPLIED PHYSICS LETTERS 87,0139012005, and IEE Proc.-Circuits Devices Syst, Vol. 152, No. 4, August 2005). The MR head is mounted on a magnetic reproducing apparatus, and reads information from a magnetic recording medium such as a hard disk drive.

An example in which a large magnetoresistive effect is realized by using a spin valve film is reported. The spin valve film is a multilayer film having a sandwich structure in which a nonmagnetic layer is sandwiched by two ferromagnetic layers. A magnetization direction of one of the ferromagnetic layers is fixed by an exchange bias magnetic field from an antiferromagnetic layer, and it is called as a “pinned layer” or a “magnetization fixed layer”. The magnetization direction of the other ferromagnetic layer is rotatable by an external magnetic field (signal magnetic field, and so on), and it is also called as a “free layer” or a “magnetization free layer”. The nonmagnetic layer is called as a “spacer layer” or an “intermediate layer”. A relative angle of the magnetization directions of these two ferromagnetic layers is changed by the external magnetic field, and thereby, a large magnetoresistive effect can be obtained.

Here, there are a CIP (Current-in-Plane) type and a CPP (Current Perpendicular to Plane) type in the magnetoresistive effect element using the spin valve film. A sense current is flowed in a parallel direction of the film surface of the spin valve film in a former case, and the sense current is flowed in a perpendicular direction of the film surface of the spin valve film in a latter case.

In recent years, a magnetoresistive effect with high magnetoresistance ratio is observed by using a magnetic micro coupling between Ni fine lines with each other (refer to Phys. Rev. Lett. 822923 (1999)). Besides, a development of a magnetoresistive effect element in which this magnetic micro coupling is expanded into a three-dimensional structure has been advanced (refer to JP-A 2003-204095 (KOKAI)). In Patent Document 1, an EB (Electron Beam) irradiation process, an FIB (Focused Ion Beam) irradiation process, an AFM (Atomic Force Microscope) technique, and so on are disclosed as a creation method of nanocontact in three-dimensional direction, namely, as a bore method.

### SUMMARY OF THE INVENTION

It is conceivable that a magnetoresistive effect at a magnetic micro coupling point is generated by a rapid change of magnetization. Namely, it leads to a high magnetoresistive effect to narrow down a magnetic domain formed at the magnetic micro coupling point. As an indirect method to narrow down a magnetic domain width, it can be cited to make a diameter of the magnetic micro coupling point (diameter of a ferromagnetic metal portion inside of a composite spacer layer) small. However, there is a possibility that resistance becomes excessively large if the diameter of the magnetic micro coupling point is made minute.

In consideration of the above, an object of the present invention is to provide a current-perpendicular-to-plane type magnetoresistive effect element, a magnetic head, a magnetic reproducing apparatus, and a manufacturing method thereof in which both an adequate resistance value and a high resistance change ratio are compatible in the magnetoresistance using the ferromagnetic nanocontact.

A magnetoresistive effect element according to an aspect of the present invention, includes: a magnetoresistive effect film includes: a magnetization fixed layer having a first ferromagnetic film of which magnetization direction is practically fixed in one direction; a magnetization free layer having a second ferromagnetic film of which magnetization direction changes with corresponding to an external magnetic field; and a spacer layer disposed between the magnetization fixed layer and magnetization free layer, and having an insulating layer and a ferromagnetic metal portion penetrating through the insulating layer; a pair of electrodes applying a sense current in a perpendicular direction relative to a film surface of the magnetoresistive effect film; and a layer containing a non-ferromagnetic element disposed at least one of an inside of the magnetization fixed layer and an inside of the magnetization free layer.

A manufacturing method of a magnetoresistive effect element according to an aspect of the present invention, includes: forming a first magnetic layer; forming a spacer layer including the steps of; forming a first metal layer over the first magnetic layer; performing a treatment to the first metal layer; oxidizing the first metal layer; and forming a second magnetic layer over the spacer layer, wherein one of the steps of forming the first magnetic layer and second magnetic layer includes forming a layer containing a non-ferromagnetic element.

### BRIEF DESCRIPTION OF THE DRAWINGS

FIG. 1 is a schematic view showing a cross section of a magnetoresistive effect element according to an embodiment of the present invention.

FIG. 2A is a schematic view showing a cross section of the magnetoresistive effect element in a vicinity of a composite spacer layer.

FIG. 2B is a schematic view showing the cross section of the magnetoresistive effect element in the vicinity of the composite spacer layer.

FIG. 2C is a schematic view showing the cross section of the magnetoresistive effect element in the vicinity of the composite spacer layer.

FIG. 3A is a schematic view showing simulation conditions;

FIG. 3B is a graphic chart showing a relation between a distance in a thickness direction and an angle change of magnetization in a vicinity of a ferromagnetic metal layer.

FIG. 3C is a graphic chart showing a relation between a diameter or a thickness of the composite spacer layer and a degree of change of the magnetization.

FIG. 4A is a view showing a spatial distribution of the magnetization when a domain wall limiting layer is inserted.

FIG. 4B is a view showing the spatial distribution of the magnetization when the domain wall limiting layer is not inserted.

FIG. 5 is a graphic chart showing a distance-magnetization characteristic.

FIG. 6 is a graphic chart showing a relation between a position of the domain wall limiting layer and a maximum magnetization.

FIG. 7 is a flowchart showing an example of a manufacturing process of the magnetoresistive effect element.

FIG. 8 is a graphic chart showing a measurement result of an MR ratio of magnetoresistance of the magnetoresistive effect element.

FIG. 9 is a view showing a state in which the magnetoresistive effect element according to the embodiment of the present invention is incorporated in a magnetic head.

FIG. 10 is a view showing a state in which the magnetoresistive effect element according to the embodiment of the present invention is incorporated in the magnetic head.

FIG. 11 is a substantial part perspective view exemplifying a schematic configuration of a magnetic recording/reproducing apparatus.

FIG. 12 is an exploded perspective view in which a head gimbal assembly at a tip portion from an actuator arm is viewed from a disk side.

### DESCRIPTION OF THE EMBODIMENTS

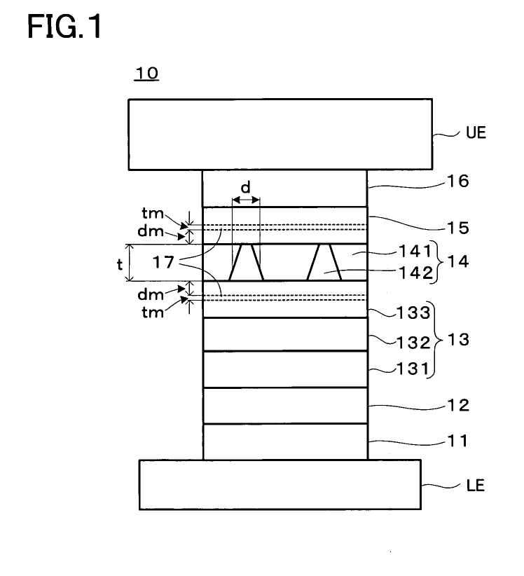

Hereinafter, embodiments of the present invention are described in detail with reference to the drawings. FIG. 1 is a schematic view showing a cross section of a magnetoresistive effect element 10 according to an embodiment of the present invention.

The magnetoresistive effect element 10 has a lower electrode LE, an upper electrode UE, and a laminated film (magnetoresistive effect film) disposed between them. This laminated film has a base layer 11, an antiferromagnetic layer 12, a composite pinned layer 13 (a pinned layer 131, a magnetization antiparallel coupling layer 132 and a pinned layer 133), a composite spacer layer 14, a free layer 15, and a protective layer 16. Here, the composite pinned layer 13, composite spacer layer 14, and free layer 15 as a whole are a spin valve film.

These lower electrode LE and upper electrode UE are to apply a sense current in an approximately perpendicular direction of the spin valve film. Namely, the magnetoresistive effect element 10 is a CPP (Current Perpendicular to Plane) type element flowing the sense current in the perpendicular direction relative to an element film surface.

The base layer 11 can be set to be, for example, a two layer structure composed of a buffer layer 11a and a seed layer 11b. The buffer layer 11a is a layer to absorb a roughness of a surface of the lower electrode LE, and for example, Ta, Ti, W, Zr, Hf, Cr, or an alloy of the above can be used. The seed layer 11b is a layer to control a crystal orientation of the spin valve film, and for example, Ru, (FeₓNi₁₀₀₋ₓ)_{100-y}x_{y} (X═Cr, V, Nb, Hf, Zr, Mo, 15<x<25, 20<y<45) can be used.

An antiferromagnetic material (for example, PtMn, PdPtMn, IrMn, RuRhMn) having a function to fix magnetization by supplying an unidirectional anisotropy to the composite pinned layer 13 is used for the antiferromagnetic layer 12.

The composite pinned layer (magnetization fixed layer) 13 has a ferromagnetic film (here, the pinned layers 131, 133) of which magnetization direction is practically fixed. The composite pinned layer 13 is composed of the two pinned layers (magnetization fixed layers) 131, 133, and the magnetization antiparallel coupling layer 132 disposed between them. Incidentally, a single pinned layer can be used instead of this composite pinned layer 13.

The upper and lower pinned layers 131, 133 of the magnetization antiparallel coupling layer 132 are magnetically coupled so that the magnetization directions thereof become antiparallel via the magnetization antiparallel coupling layer 132. Ferromagnetic materials (for example, Fe, Co, Ni, FeCo alloy, FeNi alloy) are used for the pinned layers 131, 133. The magnetization antiparallel coupling layer 132 is to antiferromagnetically couple the pinned layers 131, 133, and for example, Ru, Ir, Rh are used.

The composite spacer layer 14 has an insulating layer 141 and a ferromagnetic metal layer (ferromagnetic metal portion) 142.

The insulating layer 141 can be composed of an oxide, nitride, oxynitride, carbide, and so on containing at least one kind from among Al, Mg, Li, Si, Ca, Sc, Ti, V, Cr, Mn, Fe, Co, Ni, Cu, Zn, Ga, Se, Sr, Y, Zr, Nb, Mo, Pd, Ag, Cd, In, Sn, Sb, Ba, Ka, Hf, Ta, W, Re, Pt, Hg, Pb, Bi, and a lanthanoide element. A material having a function to insulate current can be accordingly used for the insulating layer 141.

The ferromagnetic metal layer 142 is a pass to flow the current in a layer-perpendicular direction of the composite spacer layer 14, and a ferromagnetic material such as Fe, Co, Ni, or a metal layer composed of an alloy can be used. A magnetic field opposite to the magnetization direction of the pinned layer 133 is applied to the free layer 15, and when the magnetization direction of the free layer 15 faces to the magnetic field direction, the magnetization directions of the pinned layer 133 and the free layer 15 become antiparallel. In this case, the ferromagnetic metal layer 142 is sandwiched by two ferromagnetic layers (the pinned layer 133, the free layer 15) of which magnetization directions are different, and thereby, a domain wall DW is generated at the ferromagnetic metal layer 142.

As shown in FIG. 1, a diameter d of the ferromagnetic metal layer 142 is not necessarily uniform in the layer direction (a width at a lower portion is larger than a width at an upper portion in FIG. 1). In this case, an average value in the layer direction can be adopted as a representative value of the diameter d of the ferromagnetic metal layer 142.

In the present embodiment, a ratio of the diameter d relative to a thickness t of the composite spacer layer 14 (aspect ratio) is set to be large. For example, the thickness t is set to 1 nm, the diameter d is set to 3 nm (aspect ratio becomes 3). Here, the diameter d is set to be large so as to prevent an increase of a resistance value of the magnetoresistive element.

The free layer (magnetization free layer) 15 is a layer having a ferromagnetic material (for example, Fe, Co, Ni, FeCo alloy, FeNi alloy) of which magnetization direction changes with corresponding to an external magnetic field. Incidentally, the free layer 15 may have a lamination structure in which plural layers are laminated.

The protective layer 16 has a function to protect the spin valve film. The protective layer 16 may be made to be, for example, plural metal layers, for example, a two layer structure of Cu/Ru, or a three layer structure of Cu/Ta/Ru.

### (Domain Wall Limiting Layer 17)

In the present embodiment, a thickness x of the domain wall DW is limited by the domain wall limiting layer 17, and thereby, it becomes easy to properly set both a resistance value in itself and a magnetoresistance ratio thereof. In the present embodiment, the domain wall limiting layers 17 are disposed in a vicinity of the composite spacer layer 14, concretely speaking, at one or both of the pinned layer 133 and the free layer 15. This domain wall limiting layer 17 may be disposed in plural layers without being limited to one layer.

The domain wall limiting layer 17 is a layer containing a non-ferromagnetic element. Namely, the domain wall limiting layer 17 does not have ferromagnetism, and thereby, a transmission of a ferromagnetic coupling is disturbed, and the thickness λ of the domain wall DW is limited. The domain wall limiting layer 17 weakens the ferromagnetic coupling between the composite spacer layer 14 and the pinned layer 133, or between the composite spacer layer 14 and the free layer 15. As the non-ferromagnetic element, every element existing in a periodic table except for Fe, Co, Ni can be used. Among them, for example, the elements such as H, C, N, O, F, Li, Mg, Al, Si, Ti, V, Cr, Mn, Cu, Zn, Zr, Y, Nb, Mo, Pd, Ag, Cd, Au, Pt, Pb, Bi, W, Hf, La, Ta, Ba, Sr, Re, and lanthanoid series are preferable. The element which is particularly preferable among them is Cu. The non-ferromagnetic element domain wall limiting layer 17 may be either a crystal system or an amorphous system.

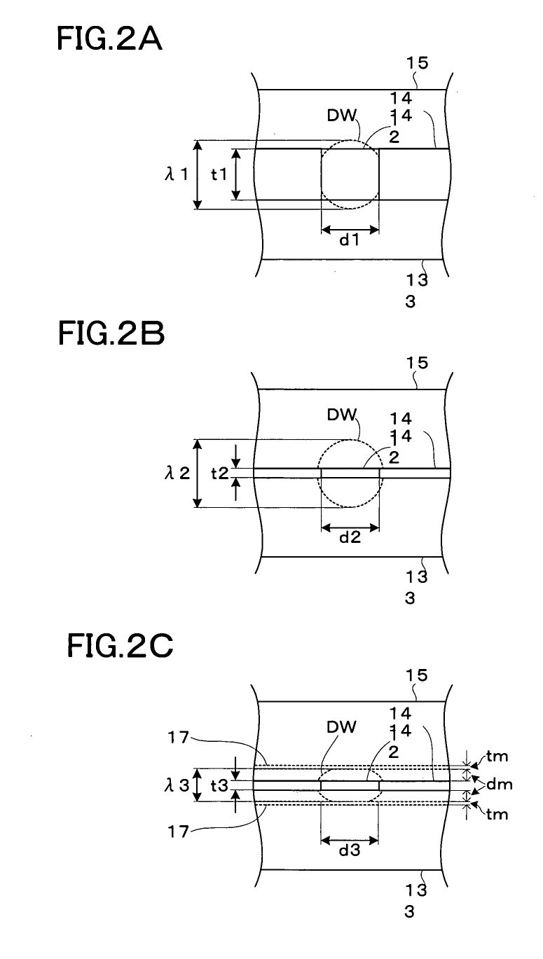

FIG. 2A to FIG. 2C are schematic views showing cross sections of the magnetoresistive effect element 10 in a vicinity of the composite spacer layer 14, and they are to describe a role of the domainwall limiting layer 17. FIG. 2A and FIG. 2B show in the vicinity of the composite spacer layer 14 when the domain wall limiting layer 17 does not exist. In FIG. 2A, a thickness t1 of the composite spacer layer 14 and a diameter d1 of the ferromagnetic metal layer 142 are approximately equal. In FIG. 2B, a diameter d2 of the ferromagnetic metal layer 142 is large relative to a thickness t2 of the composite spacer layer 14. FIG. 2C shows in the vicinity of the composite spacer layer 14 when the domain wall limiting layer 17 exists. A thickness t3 of the composite spacer layer 14 and a diameter d3 of the ferromagnetic metal layer 142 in FIG. 2C are the same as in FIG. 2B. FIG. 2C in which the domain wall limiting layer 17 exists is the present embodiment.

As it is already mentioned previously, the domain wall DW is formed at the ferromagnetic metal layer 142. The magnetization directions of the pinned layer 133, free layer 15 are different, and therefore, the domain wall DW is generated at the ferromagnetic metal layer 142 which is sandwiched by the pinned layer 133 and free layer 15 and composed of the ferromagnetic material. The domain wall DW means a boundary between magnetic domains, and an orientation of a magnetic moment changes inside of the domain wall DW. There is a possibility that this domain wall DW may spread not only to the ferromagnetic metal layer 142 in itself but also to a periphery thereof.

In FIG. 2A, the thickness t1 of the insulating layer 141 and the diameter d1 of the ferromagnetic metal layer 142 are approximately equal. Accordingly, a thickness λ1 of the domain wall DW is approximately equal to the thickness t1 of the insulating layer 141 (λ1˜d1˜t1). Correspondingly, in FIG. 2B, the diameter d2 of the ferromagnetic metal layer 142 is larger than the thickness t2 of the insulating layer 141 (d2>t2). At this time, a thickness λ2 of the domain wall DW is approximately equal to the diameter d2 of the ferromagnetic metal layer 142 (λ2˜d2). As a result of this, a protrusion of the domain wall DW from the composite spacer layer 14 (spread to periphery) becomes large.

As stated above, a thickness λ of the domain wall DW depends on both the thickness t of the insulating layer 141 and the diameter d of the ferromagnetic metal layer 142. It becomes necessary to set both the thickness t of the insulating layer 141 and the diameter d of the ferromagnetic metal layer 142 to 1 nm to make the thickness λ of the domain wall DW to 1 nm. However, there is a fear of an excessive increase of the resistance of the magnetoresistive effect element 10 if the diameter d of the ferromagnetic metal layer 142 is set to 1 nm. In the present embodiment, the domain wall limiting layers 17 are disposed at one or both of the pinned layer 133 and the free layer 15. As a result, it becomes possible to limit the thickness λ of the domain wall DW and to improve the magnetoresistance ratio without reducing both the thickness t of the insulating layer 141 and the diameter d of the ferromagnetic metal layer 142. As shown in FIG. 2C of the present embodiment, a thickness λ3 of the domain wall DW can be limited by the domain wall limiting layer 17. The domain wall limiting layer 17 weakens the ferromagnetic coupling inside of the pinned layer 133 or the free layer 15, and suppresses the spread of the domain wall DW.

In the present embodiment, it is preferable that the diameter d of the ferromagnetic metal layer 142 is in a range of 2 nm≦d≦10 nm. The diameter d of the ferromagnetic metal layer 142 is preferable to be small to some extent from a point of view of the magnetoresistance ratio. On the other hand, it is preferable that the diameter d is to be large to some extent to prevent the excessive increase of the resistance of the magnetoresistive effect element 10. Besides, it is permissible that the diameter d of the ferromagnetic metal layer 142 is set to be large to some extent because the thickness λ of the domain wall DW can be limited by the domain wall limiting layer 17. As stated above, a proper range of the diameter d is determined from a balance of the magnetoresistance ratio and the resistance value.

Besides, it is preferable that a distance dm from the composite spacer layer 14 to the domain wall limiting layer 17 is set to “0” (zero) nm<dm<3 nm. However, a more preferable range which is more effective for a confinement of the domain wall DW is “0” (zero) nm<dm≦1.5 nm though the spread of the domain wall DW is different depending on the diameter d of the ferromagnetic metal layer 142 and the thickness t of the insulating layer 141. Besides, a thickness tm of the domain wall limiting layer 17 is preferable to be 0.1 nm<tm<2 nm. Further, a more preferable range is 0.1 nm<tm≦0.5 nm.

### (Study by Simulation)

Hereinafter, a result of a simulation of a magnetization state in the vicinity of the ferromagnetic metal layer 142 is described.

### A. Study of Thickness t of Insulating Layer 141, Diameter d of Ferromagnetic Metal Layer 142

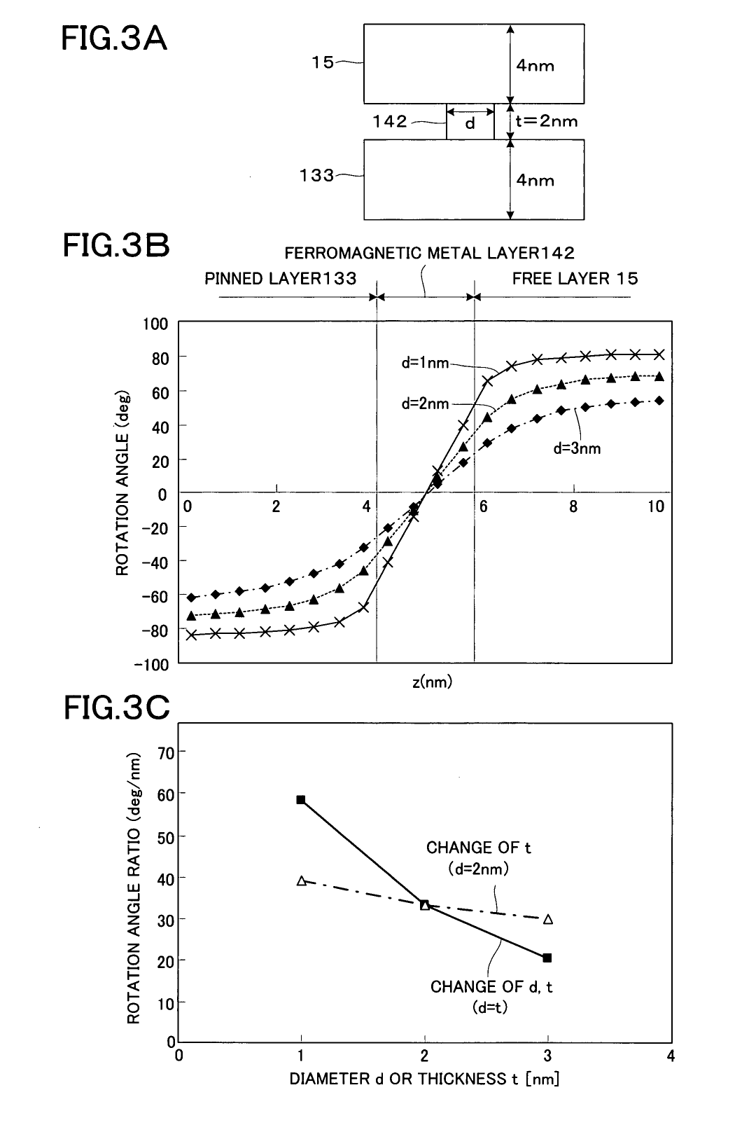

Influences of the thickness t of the insulating layer 141, the diameter d of the ferromagnetic metal layer 142 are studied. FIG. 3A is a schematic view showing simulation conditions. The thickness of the pinned layer 133 is set to 4 nm, the thickness of the free layer 15 is set to 4 nm, and the thickness t of the insulating layer 141 is set to 2 nm.

The diameter d of the ferromagnetic metal layer 142 is changed from 1 nm to 3 nm under the above condition, and an angle change of the magnetization inside of and in the vicinity of the ferromagnetic metal layer 142 is asked. FIG. 3B is a graphic chart showing a relation between a distance Z in a thickness direction of the pinned layer 133, the ferromagnetic metal layer 142 and the free layer 15, and the angle change (Rotation Angle [deg]) of the magnetization. As it is obvious from this drawing, the angle change of the magnetization is the steepest when the diameter d of the ferromagnetic metal layer 142 is 1 nm. Namely, it is expected that the smaller the diameter d is, the larger the angle change of the magnetization becomes and the larger the magnetoresistance becomes.

Besides, the angle change of the magnetization is asked while changing the thickness t of the insulating layer 141 (ferromagnetic metal layer 142). FIG. 3C is a graphic chart showing a relation between the diameter d (or thickness t) of the ferromagnetic metal layer 142 and a degree of change of the magnetization (Rotation Angle Ratio [deg/nm]). Incidentally, the degree of change of the magnetization means a ratio of the angle change of the magnetization per unit thickness. The following two results are asked by this simulation.
(1) When the diameter d is fixed to be 2 nm and the thickness t is changed.
(2) When the diameter d, the thickness t are changed with the same values.

As a result, the degree of change of the magnetization at the ferromagnetic metal layer 142 is large when both the thickness t and the diameter d are 1 nm. On the other hand, when the diameter d is fixed to 2 nm, the degree of change of the magnetization is relatively small even if the thickness t is set to 1 nm. Namely, it is expected that the smaller both the diameter d and the thickness t are set, the steeper the change of the magnetization becomes, and the larger the magnetoresistance becomes.

When the diameter d and the thickness t are set to 1 nm equally, the thickness λ of the domain wall DW becomes small, and it is conceivable that the domain wall DW does not protrude from the ferromagnetic metal layer 142 (refer to FIG. 2A). On the other hand, when the diameter d is fixed to be 2 nm, and the thickness t is set to 1 nm, the thickness λ of the domain wall DW becomes large, and it is conceivable that the domain wall DW protrudes from the ferromagnetic metal layer 142 (refer to FIG. 2B). It is assumed that this presence/absence of protrusion affects on small and large of the degree of change of the magnetization.

### B. Study of Distance dm from Composite Spacer Layer 14 to Domain Wall Limiting Layer 17

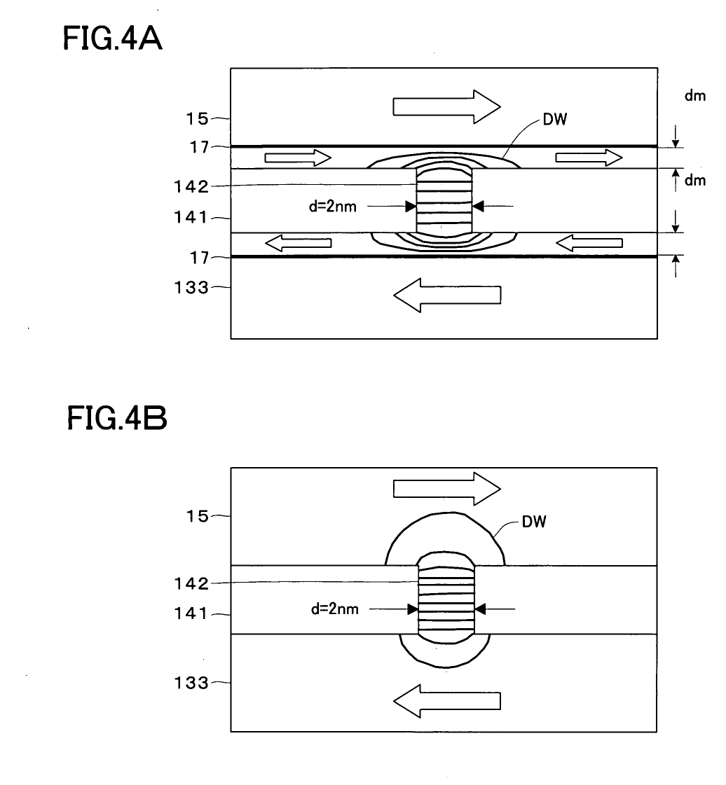

The influence of the distance dm from the composite spacer layer 14 to the domain wall limiting layer 17 is studied. FIG. 4A and FIG. 4B are views respectively showing simulation results of spatial distributions of the magnetizations in cases when the domain wall limiting layer 17 is inserted and it is not inserted. Here, the diameter d of the ferromagnetic metal layer 142 is set to 2 nm, the thickness thereof is set to 2 nm, and the magnetization directions of the pinned layer 133 and the free layer 15 are made antiparallel. In FIG. 4A, the distance dm from the composite spacer layer 14 to the domain wall limiting layer 17 is set to 0.5 nm. As it is obvious from FIG. 4A, FIG. 4B, the thickness, of the domain wall DW is limited by inserting the domain wall limiting layer 17.

FIG. 5 is a graphic chart showing a simulation result of a relation between a distance Z from an upper surface of the composite spacer layer and the magnetization in an external magnetic field direction. A horizontal axis of the graph represents the distance Z from the composite spacer layer 14, and a vertical axis of the graph represents a size of the magnetization in the external magnetic field direction, respectively. In FIG. 5, only a movement of the magnetization inside of the free layer 15 is shown. Here, the insertion distance dm of the domain wall limiting layer 17 is changed. It can be seen that the change of the magnetization becomes steep as the distance dm is made smaller such as from 1.25 nm to “0” (zero) nm. Finally, the magnetic coupling between the ferromagnetic metal layer 142 and the free layer 15 is completely cut when the insertion distance dm is set to “0” (zero) nm.

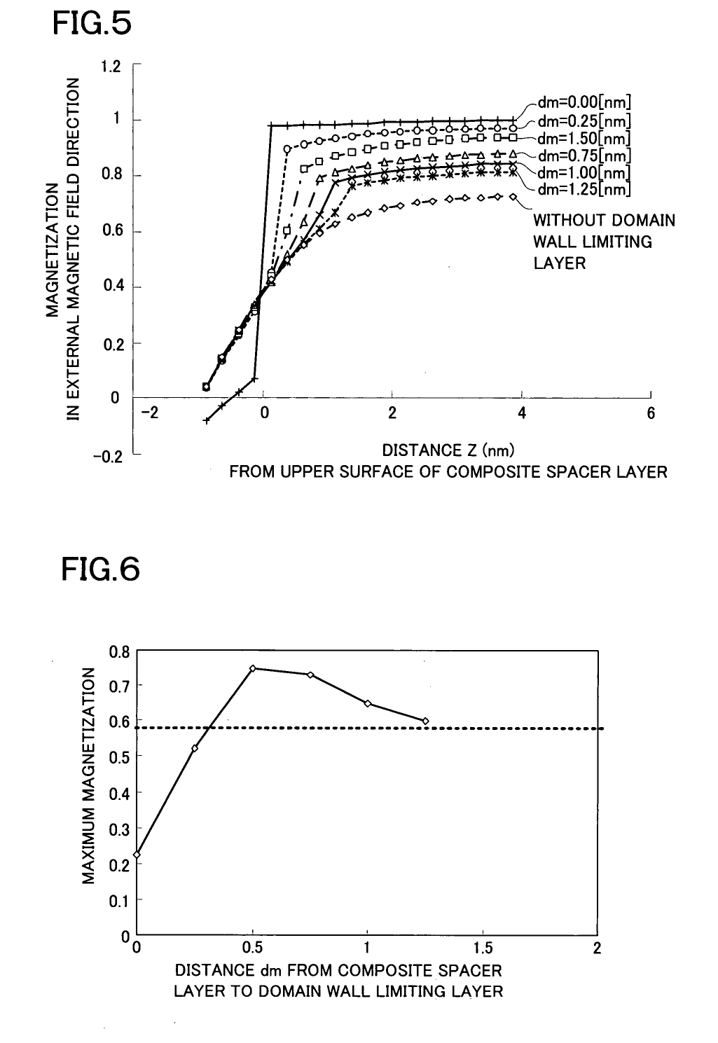

A relation between the maximum change amount of the magnetization and the insertion distance dm is asked from the result in FIG. 5. Here, a jump component in which the magnetization does not change continuously is excluded. The result is shown in FIG. 6. FIG. 6 is a graphic chart showing a relation between a position of the domain wall limiting layer 17 (the distance dm from the composite spacer layer 14 to the domain wall limiting layer 17) and the maximum change amount of the magnetization (described as the “maximum magnetization” in the drawing). This maximum magnetization is calculated while excluding the jump of the magnetization as stated above. As shown in the drawing, the maximum magnetization becomes large as the distance dm becomes small until the distance dm becomes 0.5 nm. However, when the distance dm becomes smaller than 0.5 nm, the maximum magnetization decreases rapidly. This is caused by a fact that the above-stated jump of the magnetization becomes large if the distance dm becomes small to some extent. As stated above, the change of the magnetization becomes the maximum when the distance dm from the composite spacer layer 14 to the domain wall limiting layer 17 is 0.5 nm. It is also expected that the magnetoresistance ratio becomes large at this time.

### (Manufacturing Method of Magnetoresistive Effect Element 10)

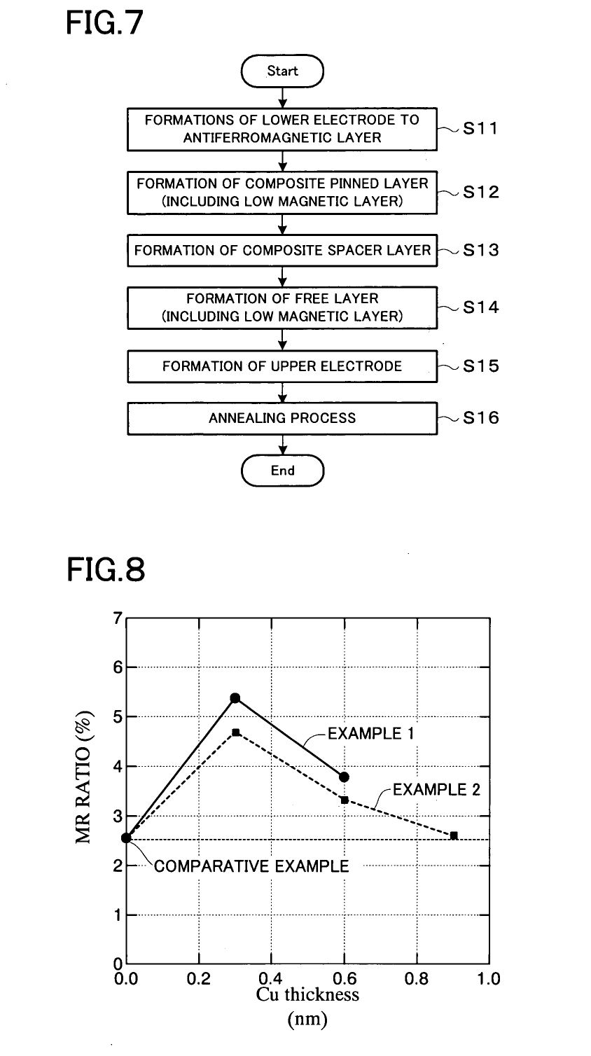

Hereinafter, an example of a manufacturing method of the magnetoresistive effect element 10 is described. FIG. 7 is a flowchart showing an example of the manufacturing method of the magnetoresistive effect element 10. The lower electrode LE, the base layer 11, the antiferromagnetic layer 12, the composite pinned layer 13, the composite spacer layer 14, the free layer 15, the protective layer 16, and the upper electrode UE are sequentially formed on a substrate. Generally, this formation is performed under a reduced pressure.

### (1) Formations of Lower Electrode LE to Antiferromagnetic Layer 12 (Step S11)

The lower electrode LE is formed on the substrate (not shown) by a microfabrication process. The base layer 11 and the antiferromagnetic layer 12 are sequentially film-formed on the lower electrode LE.

### (2) Formation of Composite Pinned Layer 13 (Including Domain Wall Limiting Layer 17) (Step S12)

The composite pinned layer 13 including the domain wall limiting layer 17 is formed on the antiferromagnetic layer 12. Namely, the pinned layer 131, the magnetization antiparallel coupling layer 132, and the pinned layer 133 are sequentially film-formed. The domain wall limiting layer 17 is formed in the middle of the film-formation (or prior to the film-formation) of the pinned layer 133. It becomes possible to insert the domain wall limiting layer 17 into the pinned layer 133 by sequentially switching film-formation materials such as a composing material of the pinned layer 133, a composing material of the domain wall limiting layer 17, and the composing material of the pinned layer 133.

### (3) Formation of Composite Spacer Layer 14 (Step S13)

Next, the composite spacer layer 14 is formed. The following method is used to form the composite spacer layer 14. Here, a case when the composite spacer layer 14 including the ferromagnetic metal layer 142 composed of Fe having a metal crystal structure is formed inside of the insulating layer 141 composed of Al₂O₃ is described as an example.

1) After a first metal layer (for example, Fe) to be a supply source of the ferromagnetic metal layer 142 is film-formed on the pinned layer 133 or at the pinned layer 133 in itself, a second metal layer (for example, Al) converted into the insulating layer 141 is film-formed on the first metal layer. A treatment (ion treatment) is performed by irradiating an ion beam of rare gas (for example, Ar) to the second metal layer. As a result of the ion treatment, it becomes a state in which a part of the first metal layer penetrates into the second metal layer. The composing material of the first metal layer penetrating into the second metal layer as stated above becomes the ferromagnetic metal layer 142.

2) Next, the insulating layer 141 is formed by supplying oxidized gas (for example, rare gas containing oxygen) to oxidize the second metal layer. At this time, a condition in which the ferromagnetic metal layer 142 is difficult to be oxidized is selected. The second metal layer is converted into the insulating layer 141 composed of Al₂O₃ by this oxidation. As a result, the composite spacer layer 14 having the insulating layer 141 composed of Al₂O₃ and the ferromagnetic metal layer 142 composed of Fe is formed. The oxidation method used here is not limited as long as it satisfies the condition in which the ferromagnetic metal layer 142 is not oxidized. Any of an ion beam oxidation method, a plasma oxidation method, an ion assist oxidation method, and so on can be used. Incidentally, it is possible to select a nitridation process, a carbonization process instead of the oxidation process.

Besides, the following 1)′, 2)′ processes are applicable instead of the above-stated 1), 2) processes.

1)′ The first metal layer (for example, Fe) to be a supply source of the ferromagnetic metal layer 142 is film-formed on the pinned layer 133 or at the pinned layer 133 in itself. After that, the second metal layer (for example, Al) to be converted into the insulating layer 141 is film-formed on the first metal layer. After the film-formation of the second metal layer, the second metal layer is oxidized by supplying the oxidized gas (for example, the rare gas containing oxygen) to form an insulating layer 141′. The oxidation method is not limited, and any of the ion beam oxidation method, the plasma oxidation method, the ion assist oxidation method, a natural oxidation method, and so on can be used. Incidentally, it is possible to select the nitridation process, the carbonization process instead of the oxidation process.

2)′ Next, a post-treatment (ion treatment) is performed by irradiating the ion beam of rare gas (for example, Ar) to the insulating layer 141′. As a result of the ion treatment, it becomes a state in which the first metal layer penetrates into the insulating layer 141′. As a result of this, the composite spacer layer 14 having the insulating layer 141′ composed of Al₂O₃ and the ferromagnetic metal layer 142 composed of Fe is formed.

### (4) Formation of Free Layer 15 (Including Domain Wall Limiting Layer 17) (Step S14)

The free layer 15 including the domain wall limiting layer 17 is formed on the composite spacer layer 14. The domain wall limiting layer 17 is formed in the middle of the film-formation (or prior to the film-formation) of the free layer 15. It is possible to insert the domain wall limiting layer 17 into the free layer 15 by sequentially switching film-formation materials such as a composing material of the free layer 15, a composing material of the domain wall limiting layer 17, and the composing material of the free layer 15.

### (5) Formation of Protective Layer 16 and Upper Electrode UE (Step S15)

The protective layer 16 and the upper electrode UE are sequentially formed on the free layer 15.

### (6) Heat Treatment (Step S16)

The magnetization direction of the composite pinned layer 13 is fixed by performing a heat treatment (annealing) to the prepared magnetoresistive effect element 10 within the magnetic field.

### EXAMPLE 1

An example 1 of the magnetoresistive effect element 10 is described. In the example 1, the magnetoresistive effect element 10 having a film configuration as stated below is prepared.
Base layer 11: Ta [5 nm]/NiFeCr [7 nm]
Antiferromagnetic layer 12: PtMn [15 nm]
Pinned layer 131: Co₉Fe₁ [3.3 nm]
Magnetization antiparallel coupling layer 132: Ru [0.9 nm]
Pinned layer 133: Fe₅Co₅ [2 nm]/Cu [x nm]/Fe₅Co₅ [0.5 nm]
Composite spacer layer 14: Al oxide/FeCo metal layer Al [1 nm] is film-formed, the ion treatment is performed, and thereafter, the oxidation process is performed under a presence of Ar ions.
Free layer 15: Fe₅Co₅ [0.5 nm]/Cu [x nm]/Fe₅Co₅ [2 nm]
Protective layer 16: Cu [1 nm]/Ta [2 nm]/Ru [15 nm]

Here, “x” is set to 0.3 and 0.6, and two kinds of elements are prepared. The prepared magnetoresistive effect elements 10 are put in the magnetic field, and the heat treatment is performed at 270° C. for approximately 10 hours.

As stated above, in the example 1, the domain wall limiting layer 17 (Cu [x nm]) is inserted into both the pinned layer 133 (Fe₅Co₅ [2.5 nm]) and the free layer 15 (Fe₅CO₅ [2.5 nm]). Besides, the distance dm of the domain wall limiting layer 17 from the composite spacer layer 14 is set to 0.5 nm in either of the pinned layer 133 and the free layer 15.

### EXAMPLE 2

An example 2 of the magnetoresistive effect element 10 is described. In the example 2, the magnetoresistive effect element 10 having the following film configuration is prepared.
Base layer 11: Ta [5 nm]/NiFeCr [7 nm]
Antiferromagnetic layer 12: PtMn [15 nm]
Pinned layer 131: Co₉Fe₁ [3.3 nm]
Magnetization antiparallel coupling layer 132: Ru [0.9 nm]
Pinned layer 133: Fe₅Co₅ [2.5 nm]
Composite spacer layer 14:Al [1 nm] is film-formed, and thereafter, the oxidation process is performed under the presence of Ar ions after the ion treatment is performed.
Free layer 15: Fe₅Co₅ [0.5 nm]/Cu [x nm]/Fe₅Co₅ [2 nm] (x: 0.3, 0.6, 0.9)
Protective layer 16: Cu [1 nm]/Ta [2 nm]/Ru [15 nm]

Here, “x” is set to 0.3, 0.6, 0.9, and three kinds of elements are prepared. The prepared magnetoresistive effect elements 10 are put in the magnetic field, and the heat treatment is performed at 270° C. for approximately 10 hours.

As stated above, in the example 2, the domain wall limiting layer 17 (Cu [x nm]) is inserted into only the free layer 15 (Fe₅Co₅ [2.5 nm]). Besides, the distance dm of the domain wall limiting layer 17 from the composite spacer layer 14 is set to 0.5 nm.

### COMPARATIVE EXAMPLE

A comparative example of the magnetoresistive effect element 10 is described. In the comparative example, a magnetoresistive effect element which does not have the domain wall limiting layer 17 of the examples 1, 2 is prepared. Incidentally, the comparative example is the same as the examples 1, 2 except for the presence/absence of the domain wall limiting layer 17, and therefore, detailed description thereof will not be given.

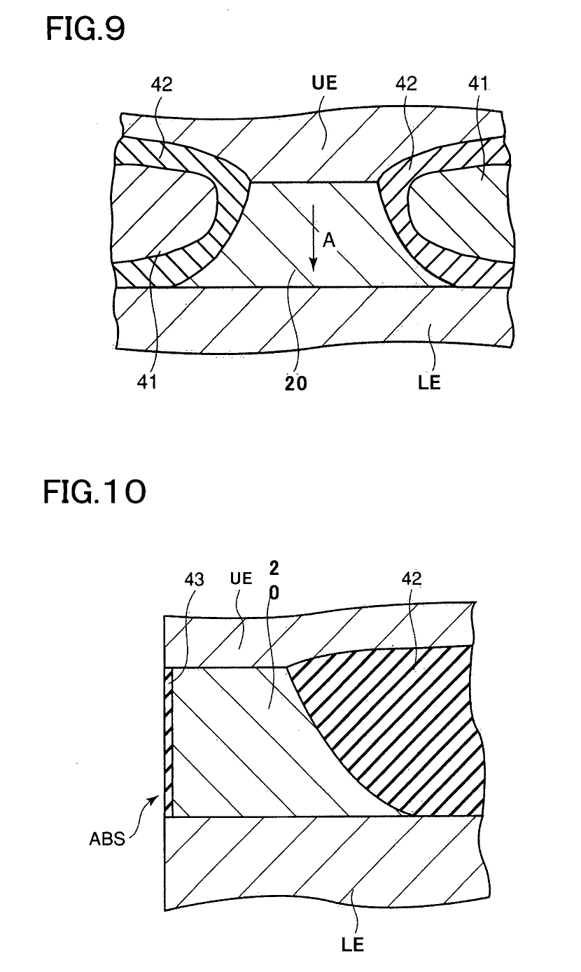

FIG. 8 is a graphic chart showing a measurement result of an MR ratio of the magnetoresistance of the magnetoresistive effect elements according to the examples 1, 2 and the comparative example. A horizontal axis, a vertical axis of this graph respectively represent the thickness of the domain wall limiting layer 17 (thickness of Cu), and the MR (magneto-resistance) ratio [%]. The MR ratio means the resistance change rate when the external magnetic field is applied to the magnetoresistive effect element. Graphs of a solid line and a dotted line respectively correspond to the examples 1, 2. Besides, the case when the thickness of the domain wall limiting layer 17 is “0” (zero) nm, corresponds to the comparative example.

As shown in the drawing, the MR ratio increases by the insertion of the domain wall limiting layer 17. When the thickness of the domain wall limiting layer 17 is set to 0.3 nm, the MR ratios of the examples 1, 2 respectively are 5.3%, 4.7%, and they are approximately double or more compared to the MR ratio of 2.6% in the comparative example. An RA at this time is 1 Ωμm² to 1.5 Ωm². The domain wall DW is limited at both sides of the composite spacer layer 14 by inserting the domain wall limiting layer 17 into the both sides of the composite spacer layer 14, and thereby, it is conceivable that the MR ratio in the example 1 becomes larger than the MR ratio in the example 2. When the thickness of the domain wall limiting layer 17 is set to be larger than 0.3 nm, the MR ratio deteriorates. When the thickness of the domain wall limiting layer 17 is 0.9 nm, the MR ratio becomes the similar value with the comparative example in which the domain wall limiting layer 17 is not inserted.

### EXAMPLE 3

An example 3 of the magnetoresistive effect element 10 is described. In the example 3, the magnetoresistive effect element 10 having the following film configuration is prepared.
Base layer 11: Ta (5 nm]/Ru [2 nm]
Antiferromagnetic layer 12: PtMn [15 nm]
Pinned layer 131: Co₉Fe₁ [3.3 nm]
Magnetization antiparallel coupling layer 132: Ru [0.9 nm]
Pinned layer 133: Fe₅Co₅ [2.2 nm]/Cu [0.5 nm]/Fe₅Co₅ [0.3 nm]
Composite spacer layer 14: Al [1 nm] is film-formed, and thereafter, the oxidation process is performed under the presence of Ar ions after the ion treatment is performed.
Free layer 15: Fe₅Co₅ [0.3 nm]/Cu [0.5 nm]/Fe₅Co₅ [2.2 nm]
Protective layer 16: Cu [1 nm]/Ta [2 nm]/Ru [15 nm]

The prepared magnetoresistive effect element 10 is put in the magnetic field, and the heat treatment is performed at 270° C. for 10 hours. The RA of the element in the example 3 is 0.6 Ωμm². Besides, an MR value at this time is observed to be 250%.

### EXAMPLE 4

An example 4 of the magnetoresistive effect element 10 is described. In the example 4, the magnetoresistive effect element 10 having the following film configuration is prepared.
Base layer 11: Ta [5 nm]/Ru [2 nm]
Antiferromagnetic layer 12: PtMn [15 nm]
Pinned layer 131: Co₀Fe₁ [3.3 nm]
Magnetization antiparallel coupling layer 132: Ru [0.9 nm]
Pinned layer 133: Fe₅Co₅ [1.5 nm]/Cu [0.3 nm]/Fe₅Co₅ [1 nm]
Composite spacer layer 14: Al [0.7 nm] is film-formed, and thereafter, the oxidation process is performed under the presence of Ar ions after the ion treatment is performed.
Free layer 15: Fe₅Co₅ [1 nm]/Cu [0.3 nm]/Fe₅Co₅ [1.5 nm]
Protective layer 16: Cu [1 nm]/Ta [2 nm]/Ru [15 nm]

The prepared magnetoresistive effect element 10 is put in the magnetic field, and the heat treatment is performed at 270° C. for 10 hours. The RA of the element in the example 4 is 0.4 Ωμm². Besides, 200% is observed as the MR value at this time.

### (Magnetic Head)

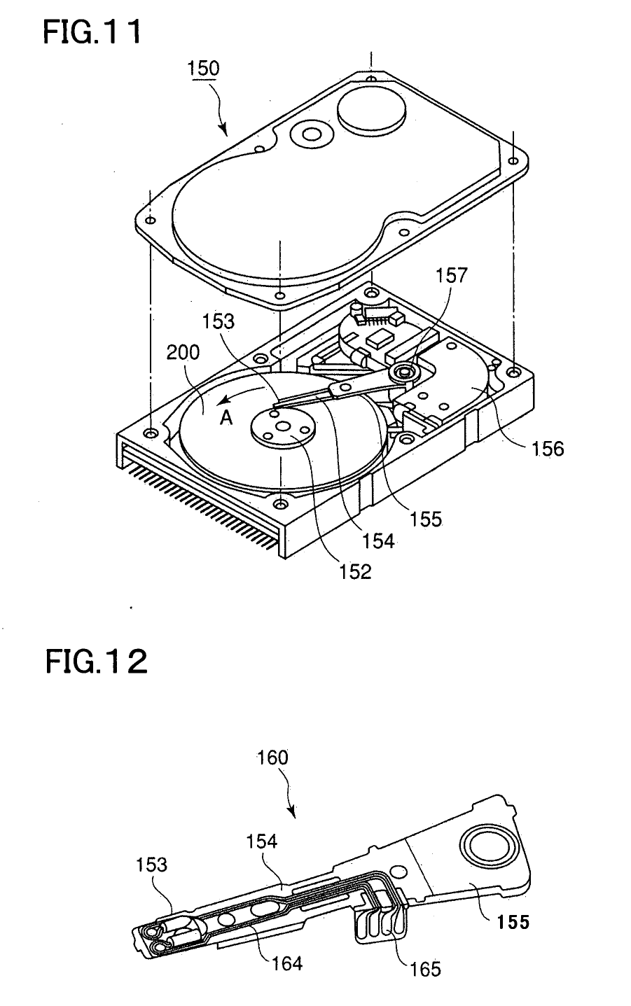

FIG. 9 and FIG. 10 show states in which the magnetoresistive effect element according to the embodiment of the present invention is incorporated in a magnetic head. FIG. 9 is a sectional view in which the magnetoresistive effect element is cut in an approximately parallel direction relative to an air bearing surface facing to a magnetic recording medium (not shown). FIG. 10 is a sectional view in which this magnetoresistive effect element is cut in a perpendicular direction relative to an air bearing surface ABS.

The magnetic head exemplified in FIG. 9 and FIG. 10 has so-called a hard abutted structure. A magnetoresistive effect film 20 is an above-stated laminated film. A lower electrode LE and an upper electrode UE are respectively provided at ups and downs of the magnetoresistive effect film 20. In FIG. 9, a bias magnetic field applying film 41 and an insulating film 42 are laminated and provided at both side surfaces of the magnetoresistive effect film 20. As shown in FIG. 10, a protective layer 43 is provided at the air bearing surface of the magnetoresistive effect film 20.

A sense current for the magnetoresistive effect film 20 is sent in an approximately perpendicular direction relative to the film surface as shown by an arrow A, by the lower electrode LE and upper electrode UE disposed at ups and downs of the magnetoresistive effect film 20. Besides, a bias magnetic field is applied to the magnetoresistive effect film 20 by a pair of bias magnetic field applying films 41 provided at right and left of the magnetoresistive effect film 20. A magnetic domain structure is stabilized and Barkhausen noise according to a movement of the domain wall can be suppressed by controlling a magnetic anisotropy of the free layer 15 of the magnetoresistive effect film 20 to make it to be a single magnetic domain by this bias magnetic field. An S/N ratio of the magnetoresistive effect film 20 is improved, and therefore, a high-sensitive magnetic reproduction becomes possible when it is applied to the magnetic head.

### (Hard Disk and Head Gimbal Assembly)

The magnetic head shown in FIG. 9 and FIG. 10 can be mounted on a magnetic recording/reproducing apparatus by incorporating in a recording/reproducing integral type magnetic head assembly. FIG. 11 is a substantial part perspective view exemplifying a schematic configuration of such a magnetic recording/reproducing apparatus. Namely, a magnetic recording/reproducing apparatus 150 of the present embodiment is an apparatus of a type in which a rotary actuator is used. In the same drawing, a magnetic disk 200 is loaded on a spindle 152, an d rotates in an arrow A direction by a not-shown motor responding to a control signal from a not-shown driving system controller. The magnetic recording/reproducing apparatus 150 of the present embodiment may include plural magnetic disks 200.

A head slider 153 performing a recording/reproducing of information stored in the magnetic disk 200 is attached to a tip portion of a thin-filmed suspension 154. The head slider 153 mounts the magnetic head including the magnetoresistive effect element according to the above-stated any one of the embodiments, in the vicinity of the tip portion of the head slider 153. When the magnetic disk 200 rotates, an air bearing surface (ABS) of the head slider 153 is held with a predetermined floating amount from a surface of the magnetic disk 200. Alternatively, the head slider 153 may be so-called a “contact running type” in which a slider is brought into contact with the magnetic disk 200.

The suspension 154 is connected to one end of an actuator arm 155. A voice coil motor 156 being a kind of a linear motor is provided at the other end of the actuator arm 155. The voice coil motor 156 is constituted by a not-shown driving coil being wound to a bobbin portion and a magnetic circuit constituted by a permanent magnet and a counter yoke disposed to face so as to sandwich the driving coil. The actuator arm 155 is held by not-shown ball bearings provided at two positions of ups and downs of the spindle 157 and a rotational sliding is made flexibly possible by the voice coil motor 156.

FIG. 12 is an exploded perspective view in which a head gimbal assembly at a tip portion from the actuator arm 155 is viewed from a disk side. Namely, an assembly 160 has the actuator arm 155, and the suspension 154 is connected to one end of the actuator arm 155. The head slider 153 having the magnetic head including the magnetoresistive effect element according to the above-stated any one of embodiments is attached to a tip portion of the suspension 154. The suspension 154 has lead lines 164 for writing and reading signals, and these lead lines 164 and respective electrodes of the magnetic head incorporated in the head slider 153 are electrically connected. A reference numeral 165 in the drawing shows electrode pads of the assembly 160. According to the present embodiment, it becomes possible to surely read information which is magnetically recorded on the magnetic disk 200 with high recording density by having the magnetic head including the above-stated magnetoresistive effect element.

### Other Embodiments

Embodiments of the present invention can be expanded/modified without being limited to the above-described embodiments, and such expanded/modified embodiments are also included in the technical scope of the present invention.

What is claimed is:

1. A magnetoresistive effect element, comprising:
a magnetoresistive effect film including:
a magnetization fixed layer having a first ferromagnetic film of which magnetization direction is practically fixed in one direction;
a magnetization free layer having a second ferromagnetic film of which magnetization direction changes with corresponding to an external magnetic field; and
a spacer layer disposed between the magnetization fixed layer and magnetization free layer, and having an insulating layer and a ferromagnetic metal portion penetrating through the insulating layer;
a pair of electrodes applying a sense current in a perpendicular direction relative to a film surface of said magnetoresistive effect film; and
a layer containing a non-ferromagnetic element disposed at least one of an inside of the magnetization fixed layer and an inside of the magnetization free layer.

2. The magnetization effect element according to claim 1,
wherein a distance dm between the insulating layer and said layer containing the non-ferromagnetic element is “0” (zero) nm<dm<3 nm.

3. The magnetization effect element according to claim 1,
wherein a thickness tm of said layer containing the non-ferromagnetic element is 0.1 nm<tm<2 nm.

4. The magnetization effect element according to claim 1,
wherein the non-ferromagnetic is element selected from the group A consisting of H, C, N, O, F, Li, Mg, Al, Si, Ti, V, Cr, Mn, Cu, Zn, Zr, Y, Nb, Mo, Pd, Ag, Cd, Au, Pt, Pb, Bi, W, Hf, La, Ta, Ba, Sr, Re, and a lanthanoide series element.

5. The magnetization effect element according to claim 1,
wherein the insulating layer has at least one of oxygen, nitrogen, or carbon.

6. The magnetization effect element according to claim 1,
wherein the ferromagnetic metal portion has at least one of an element selected from the group B consisting of Fe and Co.

7. The magnetization effect element according to claim 1,
wherein the ferromagnetic metal portion has a diameter greater than or equal to 2 nm.

8. The magnetization effect element according to claim 1,
wherein the ferromagnetic metal portion has a diameter less than or equal to 10 nm.

9. The magnetization effect element according to claim 1,
wherein the ferromagnetic film is an alloy composed of Fe and Co.

10. A magnetic head comprising a magnetoresistive effect element according to claim 1.

11. A magnetic reproducing apparatus comprising a magnetic head according to claim 10 reading magnetically recorded information from a magnetic recording medium.

12. A manufacturing method of a magnetoresistive effect element, comprising:
forming a first magnetic layer;
forming a spacer layer including the steps of;
forming a first metal layer over the first magnetic layer;
performing a treatment to the first metal layer;
oxidizing the first metal layer; and
forming a second magnetic layer over the spacer layer,
wherein one of the steps of forming the first magnetic layer and second magnetic layer includes forming a layer containing a non-ferromagnetic element.

13. The method according to claim 12,
wherein the treatment is performed by irradiating an ion beam of rare gas to the first metal layer.

14. The method according to claim 12,
wherein the treatment is performed by applying energy enough to excite atoms onto the first magnetic layer.

15. The method according to claim 12,
wherein the first metal layer is converted into an insulating layer by the oxidizing step.

16. A manufacturing method of a magnetoresistive effect element, comprising:
forming a first magnetic layer;
forming a spacer layer including the steps of;
forming a first metal layer over the first magnetic layer;
oxidizing the first metal layer;
performing a treatment to the first metal layer; and
forming a second magnetic layer over the spacer layer,
wherein one of the steps of forming the first magnetic layer and second magnetic layer includes forming a layer containing a non-ferromagnetic element.

17. The method according to claim 16,
wherein the treatment is performed by irradiating an ion beam of rare gas to the first metal layer.

18. The method according to claim 16, wherein the treatment is performed by applying energy enough to excite atoms onto the first magnetic layer.

19. The method according to claim 16,
wherein the first metal layer is converted into an insulating layer by the oxidizing step.
